(19) United States
(12) Patent Application Publication
(10) Pub. No.: US 2022/0223052 A1
(43) Pub. Date: Jul. 14, 2022

(54) Augmented Reality in Aircraft Cockpit Through Bi-Directional Connectivity

(71) Applicant: SMARTSKY NETWORKS LLC, Morrisville, NC (US)

(72) Inventors: Bruce J. Holmes, Williamsburg, VA (US); Elbert Stanford Eskridge, Chapel Hill, NC (US); James Evans Ladd, Hillsborough, NC (US)

(21) Appl. No.: 17/612,710

(22) PCT Filed: May 8, 2020
(86) PCT No.: PCT/US2020/032066

§ 371 Date: Nov. 19, 2021

Related U.S. Application Data
(60) Provisional application No. 62/851,921, filed on May 23, 2019.

(51) Int. Cl. G08G 5/00; H04W 4/42; G06T 19/00

(52) U.S. Cl. CPC G08G 5/0021; G08G 5/0013; G08G 5/0043; G06T 19/006; G08G 5/003; G08G 5/006; H04W 4/42; G08G 5/0091

(57) ABSTRACT

A system for improving cockpit operations in an aircraft includes an airborne augmented reality module and a ground-based information management module. The augmented reality module may be disposed in the cockpit of the aircraft and may include processing circuitry configured to generate an augmented reality display in the cockpit based at least in part on selected external environmental data received. The information management module may be configured to include external environmental data received from a plurality of sources and generate the selected external environmental data for communication to the augmented reality module via a wireless communication network while the aircraft is in flight. The selected external environmental data may be selected based on aircraft location and a determination of temporal relevance and locational relevance of the selected external environmental data.

### CROSS REFERENCE TO RELATED APPLICATIONS

This application claims priority to U.S. application No. 62/851,921 filed on May 23, 2019, the entire contents of which are hereby incorporated by reference in its entirety.

### TECHNICAL FIELD

Example embodiments generally relate to wireless communications and, more particularly, relate to providing augmented reality services to pilots using real time connectivity that can only be provided by a high bandwidth, bi-directional wireless communication link.

### BACKGROUND

A flight management system (FMS) is a computer system that is onboard an aircraft, and is specially designed to automate certain tasks in order to make the workload of the flight crew more manageable. In particular, if given a flight plan, the FMS can use sensors to determine aircraft position (along with other flight parameters) and guide the aircraft along the flight plan. In a typical situation, the FMS includes a flight management computer (FMC) and a control display unit (CDU), which is provided in the aircraft for user interface capability. The FMC manages various other components of the FMS including navigational components, flight and instrument displays, flight control systems, engine and fuel systems, data link, etc. The FMC therefore provides the primary means of controlling functions associated with navigation, flight planning, route guidance, trajectory prediction, etc. Controlling these functions typically requires interaction with various databases associated with navigation, basic operations and engine/aircraft performance data.

The database associated with navigation is called a navigation database, or NDB. The NDB is used for building and processing flight plans. The NDB (like the other databases) is stored in the FMC on a read-only memory device that is updated via a data loader. The data stored in the NDB (i.e., NDB data or information) includes waypoints, airways, runway information, holding patterns, and numerous other important aids to navigation and instructions.

As can be appreciated from the descriptions above, the FMS operates using real time information that is generated in situ, on the aircraft, and incorporates that locally gathered real time information with the static, pre-stored information to drive informational displays and operate or provide guidance for various control surfaces of the aircraft. This combination of real time information that can be locally generated with mainly static information regarding things external to the aircraft has worked reasonably well for many years. While sufficient for minimum operational and safety requirements, this paradigm could certainly use improvement.

The main problem limiting improvement has not been the imagination of those in the aviation industry. Instead, the main problem has been bandwidth. In this regard, the ability to communicate information to the aircraft in real time and, even more limiting, the ability to receive information from the aircraft in real time, has been stifling relative to the universe of what services can realistically be brought into use in the cockpit. Accordingly, some example embodiments provide tools by which to improve this situation dramatically.

### BRIEF SUMMARY OF SOME EXAMPLES

Some example embodiments may provide a communication structure capable of delivering a strong bi-directional wireless communication link. The bi-directional communication link may enable additional real time information generated external to the aircraft to be incorporated with locally generated information to deliver a vast array of augmented reality services that can improve both safety and operational performance for aircraft.

In one example embodiment, a system for improving cockpit operations in an aircraft is provided. The system includes an airborne augmented reality module and a ground-based information management module. The augmented reality module may be disposed in the cockpit of the aircraft and may include processing circuitry configured to generate an augmented reality display in the cockpit based at least in part on selected external environmental data received. The information management module may be configured to include external environmental data received from a plurality of sources and generate the selected external environmental data for communication to the augmented reality module via a wireless communication network while the aircraft is in flight. The selected external environmental data may be selected based on aircraft location and a determination of temporal relevance and locational relevance of the selected external environmental data.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a system in accordance with an example embodiment;

FIG. 2 illustrates a block diagram of an information management module in accordance with an example embodiment;

FIG. 3 illustrates a block diagram of an ARM in accordance with an example embodiment;

FIG. 4 illustrates image data overlaid in accordance with an example embodiment; and

FIG. 5 illustrates image data having numerous indicators overlaid thereon according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide a system, architectures and/or methods for improved real time services provision to aircraft by leveraging bi-directional communication links. In this regard, some example embodiments may provide a system that provides reliable, continuous and real-time connectivity to aircraft so that real time information can be incorporated into augmented reality applications running in the cockpit. In some cases, models of airports and/or airspace can be generated onto vision displays in the cockpit, and the models can be overlaid with data of various kinds. By providing a high level of reliable connectivity to the aircraft, the provision of augmented reality applications in the cockpit can add safety in ways not previously possible (e.g., generating visible representations of wake vortexes and their movement), and improve the nature of other safety and operational improvement offerings (e.g., by providing overlays on vision displays, providing real time synthetic vision and/or providing interaction through voice recognition technology) for improved guidance through connectivity.

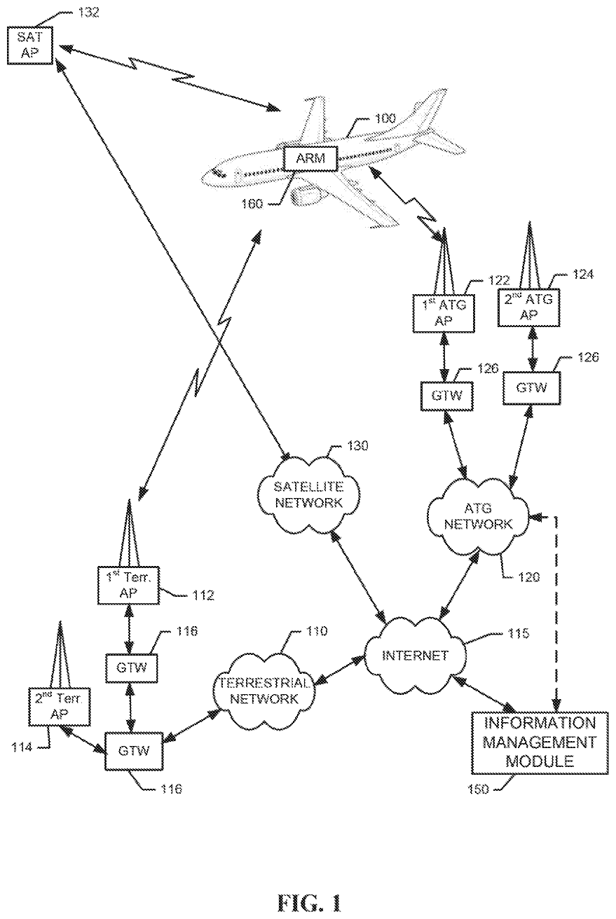

FIG. 1 illustrates a block diagram of various components of a system, which may include one or more wireless communication networks that may be employed to communicate with an aircraft 100 according to an example embodiment. In this regard, as shown in FIG. 1, a terrestrial network 110, an ATG network 120 and a satellite network 130 are each represented. However, it should be appreciated that example embodiments could be employed with only one such network, with two of the networks, or even with other networks capable of communication with the aircraft 100.

As shown in FIG. 1, each of the wireless communication networks may include wireless access points (APs) that include antennas configured for wireless communication. Thus, for example, the terrestrial network 110 may include a first terrestrial AP 112 and a second terrestrial AP 114, each of which may be base stations, among a plurality of geographically distributed base stations that combine to define the coverage area for the terrestrial network 110. The first and second terrestrial APs 112 and 114 may each be examples of terrestrial base stations that are placed adjacent to each other to provide coverage in overlapping cells that each extend outwardly from the respective base stations in substantially all directions. Thus, the terrestrial base stations may provide a constant layer of coverage near the ground and up to a maximum altitude.

The first and second terrestrial APs 112 and 114 may each be in communication with the terrestrial network 110 via a gateway (GTW) device 116. The terrestrial network 110 may further be in communication with a wide area network such as the Internet 115, Virtual Private Networks (VPNs) or other communication networks. In some embodiments, the terrestrial network 110 may include or otherwise be coupled to a packet-switched core or other telecommunications network. Thus, for example, the terrestrial network 110 may be a cellular telephone network (e.g., a 4G, 5G, LTE or other such network).

The ATG network 120 may similarly include a first ATG AP 122 and a second ATG AP 124, each of which may be base stations, among a plurality of geographically distributed base stations that combine to define the coverage area for the ATG network 120. The first and second ATG APs 122 and 124 may each be in communication with the ATG network 120 via a GTW device 126. The ATG network 120 may also be in communication with a wide area network such as the Internet 115, VPNs or other communication networks. In some embodiments, the ATG network 120 may also include or otherwise be coupled to a packet-switched core or other telecommunications network. Thus, for example, the ATG network 120 may be a network that is configured to provide wireless communication to airborne assets and may employ 4G, 5G, LTE and/or other proprietary technologies. The ATG network 120 may include base stations that define a coverage area substantially above a minimum altitude, which may or may not overlap with the maximum altitude defined by the terrestrial network 110. Moreover, in some cases, the ATG network 120 may be configured to employ beamforming technology that involves either steering narrow beams between the aircraft 100 and the base stations of the ATG network (e.g., the first and second ATG APs 122 and 124) or forming selected ones of a plurality of fixed beams that are each oriented in adjacent and overlapping areas to define full zones of coverage that also overlap. In an example embodiment, the ATG network 120 may be configured to employ unlicensed band frequencies to massively increase the bandwidth capability of the ATG network 120 beyond that of licensed band communications. Moreover, the ATG network 120 may be bidirectional in nature, such that high bandwidths and low latencies can be achieved in both directions. For example, the ATG network 120 may be capable of delivering download speeds (to the aircraft 100) of greater than 4 Mbps and an upload speed (from the aircraft 100) of greater than 1 Mbps along with latency of less than 100 ms and a jitter of less than 10,000 ms.

The satellite network 130 may include one or more ground stations and one or more satellite access points 132. The satellite network 130 may employ Ka band, Ku band, or any other suitable satellite frequencies/technologies (including Low Earth Orbit (LEO) to provide wireless communication services to the aircraft 100 either while in-flight, or on the ground. Although the satellite network 130 may have good download speeds, upload speeds can be poorer, and latency will be a significant problem for orbits above LEO. Accordingly, the ATG network 120 may be preferred to satellite communications via the satellite network 130 whenever the ATG network 120 is accessible (e.g., due to altitude limitations). However, the satellite network 130 may be a reliable or useful alternative to the ATG network 120 in some cases. Additionally, in some examples it may be desirable to have multiple networks available for establishing redundant sources of connectivity. Redundancy of communication networks may increase the overall reliability and capability of the system.

As shown in FIG. 1, an information management module 150 may be disposed at a location accessible to one or more of the networks. Thus, for example, the information management module 150 may be operably coupled to the Internet 115. However, the information management module 150 may be disposed at a particular one of the networks (e.g., the ATG network 120) in some cases. The information management module 150 may be configured to provide external environmental data (e.g., weather information, wind speed/direction, wind shear data, precipitation information, wake vortex information, animal activity (e.g., animals on or near a runway, or in flight near airports), aircraft traffic information, various special interest-related information, etc.) to an augmented reality module (ARM) 160 disposed on the aircraft 100. Moreover, it should be appreciated that the information management module 150 may be configured to communicate (including simultaneously) with many aircraft and with many individual instances of ARMs on each respective one of the aircraft. Thus, the information management module 150 may be configured to supply external environmental data to many aircraft associated with a particular airline, or with multiple different airlines, as described herein. Then, the ARM of each respective aircraft can use the external environmental data as described herein for driving outputs at the ARM 160 while the aircraft are in-flight.

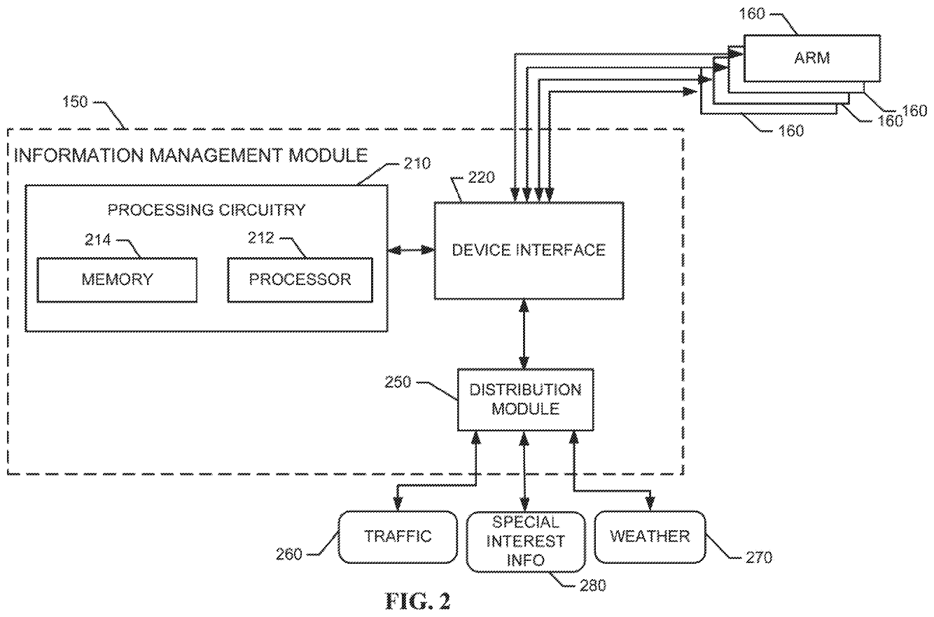

An example structure for the information management module 150 of an example embodiment is shown in the block diagram of FIG. 2. In this regard, as shown in FIG. 2, the information management module 150 may include processing circuitry 210 configured to perform data processing, control function execution and/or other processing and management services according to an example embodiment of the present invention. In some embodiments, the processing circuitry 210 may be embodied as a chip or chip set. In other words, the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include one or more instances of a processor 212 and memory 214 that may be in communication with or otherwise control a device interface 220. As such, the processing circuitry 210 may be embodied as a circuit chip (e.g., an integrated circuit chip) configured (e.g., with hardware, software or a combination of hardware and software) to perform operations described herein. In some embodiments, the processing circuitry 210 may communicate with various internal and/or external components, entities, modules and/or the like, e.g., via the device interface 220. The processing circuitry 210 may also communicate with one or more instances of the ARM 160 via one or more of the networks of FIG. 1 (and more specifically, via an antenna assembly and radio that is configured to wirelessly interface with an aircraft via the corresponding one of the networks).

The device interface 220 may include one or more interface mechanisms for enabling communication with other internal and/or external devices (e.g., modules, entities, sensors and/or other components of the networks and/or aircraft). In some cases, the device interface 220 may be any means such as a device or circuitry embodied in either hardware, or a combination of hardware and software that is configured to receive and/or transmit data from/to modules, entities, sensors and/or other components of the networks and/or aircraft that are in communication with the processing circuitry 210. In this regard, for example, the device interface 220 may be configured to operably couple the processing circuitry 210 to a distribution module 250, and/or to various external entities (including flight control entities, aircraft themselves, weather services, etc.) that may provide various types of information including traffic information 260, weather information 270, and numerous other types of information associated with specific interests (i.e., special interest information 280) with respect to which operation of the aircraft 100 may be managed, optimized or otherwise considered. These other types of special interest information 280 may include carbon management activities, rule violations, noise management issues, predictive maintenance, animal activity, logistics and management information and/or the like.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform the operations described herein.

In an example embodiment, the processor 212 (or the processing circuitry 210) may be embodied as, include or otherwise control the operation of the distribution module 250. As such, in some embodiments, the processor 212 (or the processing circuitry 210) may be said to cause each of the operations described in connection with the distribution module 250. The processor 212 may also control function execution and instruction provision related to operations of the distribution module 250 based on execution of instructions or algorithms configuring the processor 212 (or processing circuitry 210) accordingly. In particular, the instructions may include instructions for determining which information and/or services to provide to the ARM 160 of a particular aircraft, and then the provision of such information and/or services.

In an exemplary embodiment, the memory 214 may include one or more non-transitory memory devices such as, for example, volatile and/or non-volatile memory that may be either fixed or removable. The memory 214 may be configured to store information, data, applications, instructions or the like for enabling the processing circuitry 210 to carry out various functions in accordance with exemplary embodiments of the present invention. For example, the memory 214 could be configured to buffer input data for processing by the processor 212. Additionally or alternatively, the memory 214 could be configured to store instructions for execution by the processor 212. As yet another alternative, the memory 214 may include one or more databases that may store a variety of data sets associated with the traffic information 260, weather information 270 and/or special interest information 280 that is provided for storage prior to ultimate distribution by the distribution module 250. Among the contents of the memory 214, applications and/or instructions may be stored for execution by the processor 212 in order to carry out the functionality associated with each respective application/instruction.

The distribution module 250 may be configured to receive the traffic information 260, weather information 270 and/or special interest information 280, and store such information in a way that enables specific portions of such information to be requested, disseminated, updated, and/or the like. In an example embodiment, the distribution module 250 may also be configured to store all information in association with a respective location (in 2D and/or 3D space) and time. Thus, for example, each piece of external environmental data received by the distribution module 250 may be stored in association with respective geographic areas, airports, specific locations in airspace or on the ground, and a corresponding time at which the information was received so that, for example, the distribution of information to specific ARMs 160 and corresponding aircraft can be made on the basis of temporal and locational relevance (for current time or for future time, based on trajectory information).

In some examples, some or all of the information stored in the information management module 150 may be stored in association with confidence ratings so that any information having temporal and locational relevance may further be considered in light of a confidence score or rating associated with the information as well. In some cases, the confidence score or rating may be generated or change based on the age of the information, or based on knowledge of the speed at which such information decays or changes in relevance over time. For example, information about lightning strikes at a particular location may be relevant to the particular location only for a time at which the corresponding thunderstorm is in the area. Speed of movement of a weather front or storm cell (if known), may be used to generate a confidence rating for the information about lightning strikes that causes the confidence rating to be high for a certain period of time (e.g., a half hour), but then decay to the point at which the information becomes irrelevant or not useful (e.g., four hours later). Thus, weather information and certain types of traffic information can be augmented based on additional knowledge (e.g., of system or object movement and speed), or based on average or estimated speeds for movement when specific information is lacking. A starting confidence score or rating associated with various types of information may therefore be lower when less additional knowledge is available (and estimates must be used). In any case, the ARM 160 may use the confidence score to determine when and how to represent certain types of information (as discussed in greater detail below) such that, for example, the confidence score could determine color, intensity or other aspects of how a particular feature is represented, but the confidence score could also determine whether a particular feature is represented at all. In this regard, various thresholds could be defined for the confidence score with respect to how the feature is represented or whether the feature is represented at all.

In an example embodiment, the information module 150 may be configured to attempt to gather data at certain confidence intervals that are defined or based on the type of information associated therewith. For example, traffic information may have a very short confidence interval such that new information must be received and supplied to aircraft in real time or at least within minutes to several minutes in order to have any relevance due to the speed at which aircraft move (in the air and on the ground) relative to their relevance to any particular location. Weather information may have a longer confidence interval (e.g., quarter or half hour intervals) given the general size and slow speed of movement of weather systems. The confidence intervals associated with various types of the special interest information 280 may vary widely with the type of information. In some cases, data of various types that is collected from or in the aircraft 100 may also be gathered, replaced or reported at intervals that also depend upon confidence ratings associated with their accuracy. In such examples, each different type of data may have a corresponding different confidence rating or confidence interval.

In some cases, confidence ratings may be dynamic and be allowed to decay over time, as mentioned above. However, in other cases, a confidence rating associated with any particular piece of information may remain static and the corresponding piece of information may only be replaced or updated when better information is received. Thus, for example, certain types of information may be updated in the information management module 150 only when the confidence score or rating of new information received is higher than the confidence score or rating of the information being updated or replaced.

In some cases, the distribution module 250 may receive information indicative of aircraft location (or requests from aircraft for external environmental data) for a plurality of aircraft. The distribution module 250 may be configured to determine which portions of the traffic information 260, weather information 270 and/or special interest information 280 have sufficient (e.g., relative to a threshold) temporal and locational relevance to the aircraft based on the respective locations of the aircraft. In some cases, a temporal or locational relevance threshold may be defined to guide determinations as to which information to send to which respective aircraft. Similarly, a confidence rating threshold may dictate or influence which information is sent to or from respective aircraft as well. As such, any or all of the temporal relevance, locational relevance, and the confidence score of the information stored at the information management module 150 may be used by the distribution module 250 in order to determine which portions of the traffic information 260, weather information 270 and/or special interest information 280 to send to respective aircraft (and their respective ARMs 160), or from those aircraft to data systems on the ground.

The distribution module 250 may be configured to interface with the ARM 160 to distribute (e.g., wirelessly via one of the networks of FIG. 1) data or content from the information management module 150 to the ARM 160 of one or more instances of the aircraft 100. In some cases, the distribution module 250 may communicate specific information intentionally to the aircraft for which the information is most relevant (as described above). However, in some models, all information having sufficient temporal relevance to a very large region (e.g., a country or continent) may be broadcast to all aircraft in the region. The broadcast model may lower the processing and decision making load on the distribution module 250 and substantially simplify decision making on that end. However, as will be seen later, broadcasting information would simply shift the processing burden to the air-side, which may be disadvantageous in some cases. Thus, instead of broadcast communications to aircraft in general, the communications between the information management module 150 and the ARM 160 may be direct and targeted in some cases. This targeted communication may be both enabled and enhanced by the fact that the ATG network 120 of some example embodiments may be configured to utilize beamforming technology to form narrow beams between the aircraft 100 and the base stations of the ATG network (e.g., the first and second ATG APs 122 and 124). The narrow beams that are formed directly between the aircraft 100 and the base stations may also enhance security since the beams are formed with knowledge of the location of the aircraft 100 relative to the corresponding base station that is currently serving the aircraft 100. Thus, the aircraft 100 may receive only information deemed to be pertinent (e.g., having sufficient locational relevance, temporal relevance and confidence scores) to the aircraft 100, and the ARM 160 of the aircraft 100 may have a lower computational load as a consequence. Given that weight and size restrictions are lower on the ground, that power is readily available, and that one unit can service multiple aircraft, this paradigm may be favored in some embodiments.

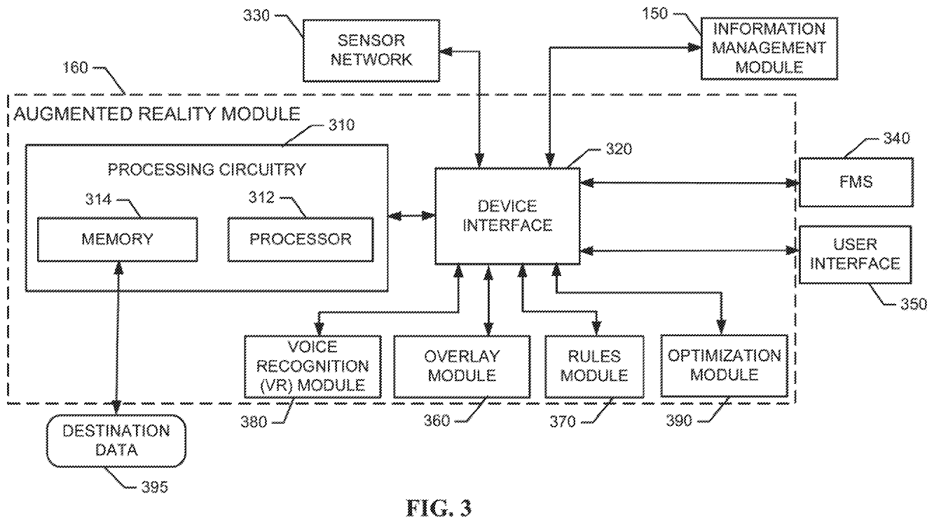

FIG. 3 illustrates a block diagram of various components of the ARM 160 of an example embodiment. In an example embodiment, the ARM 160 may include processing circuitry 310 configured to perform data processing, control function execution and/or other processing and management services according to an example embodiment of the present invention. In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320. As such, the processing circuitry 310 may be embodied as a circuit chip (e.g., an integrated circuit chip) configured (e.g., with hardware, software or a combination of hardware and software) to perform operations described herein. In some embodiments, the processing circuitry 310 may communicate with various components, entities and/or sensors of the aircraft 100, e.g., via the device interface 220. Thus, for example, the processing circuitry 310 may communicate with a sensor network 330 of the aircraft 100 to receive information from sensors on flight control surfaces, one or more cameras, equipment and environmental sensors, and/or the like. The processing circuitry 310 may also communicate with the information management module 150 via one of the networks (and more specifically, via an antenna assembly and radio that is configured to wirelessly interface with the corresponding one of the networks).

The device interface 320 may include one or more interface mechanisms for enabling communication with other internal and/or external devices (e.g., modules, entities, sensors and/or other components of the networks and/or aircraft). In some cases, the device interface 320 may be any means such as a device or circuitry embodied in either hardware, or a combination of hardware and software that is configured to receive and/or transmit data from/to modules, entities, sensors and/or other components of the networks and/or aircraft that are in communication with the processing circuitry 310. In this regard, for example, the device interface 320 may be configured to operably couple the processing circuitry 310 to the flight management system (FMS) 340 of the aircraft 100, a user interface 350, an overlay module 360, a rules module 370, a voice recognition (VR) module 380, and/or an optimization module 390 along with the information management module 150.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the overlay module 360, the rules module 370, the voice recognition module 380, and/or the optimization module 390. As such, in some embodiments, the processor 312 (or the processing circuitry 310) may be said to cause each of the operations described in connection with the overlay module 360, the rules module 370, the voice recognition module 380, and/or the optimization module 390. The processor 312 may also control function execution and instruction provision related to operations of the overlay module 360, the rules module 370, the voice recognition module 380, and/or the optimization module 390 based on execution of instructions or algorithms configuring the processor 312 (or processing circuitry 310) accordingly.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally or alternatively, the memory 314 could be configured to store instructions for execution by the processor 312. In some cases, the memory 314 may also store destination data 395 that may be provided pre-flight or in-flight. In some cases, the destination data 395 may include information provided by the information management module 150 while the aircraft 100 is in-flight. However, the destination data 395 may also be pre-loaded information modules that are loaded based on the flight plan or destination of the aircraft 100 on a given flight. In any case, the memory 314 may store applications or instructions that, when executed by the processor 312 enable launching and execution of software programs that perform various functions including, for example, several of the functions described herein.

The ARM 160 may, in some cases, be operably coupled to the FMS 340 to allow integration of the operations of the ARM 160 with the FMS 340. However, in other cases, the ARM 160 may operate separate from the FMS 340. As such, the ARM 160 could be a separate advisory or informational services platform for the pilot or crew. However, in other cases, the ARM 160 could be an input to, or even receive outputs from the FMS 340 to facilitate incorporation of the information associated with the ARM 160 into automatically generated flight controls and/or autopilot functions of the aircraft 100.

The ARM 160 may further include or be operably coupled to the user interface 350, which may be in communication with the processing circuitry 310 to receive an indication of a user input at the user interface 350 and/or to provide an audible, visual, mechanical or other output to the user (i.e., pilot or crew member). As such, the user interface 350 may include, for example, one or more instances of a keyboard, display, levers, switches, indicator lights, touchscreens, microphone, buttons or keys (e.g., function buttons), and/or other input/output mechanisms. In some cases, the user interface 350 may include a vision system (e.g., heads up display, goggles or another head mounted display that can be worn by the pilot or a crew member) to generate an immersive augmented reality environment that is visible to the pilot or crew member through the vision system. In some embodiments, the vision system may generate a synthetic vision system with a display of the vision system displaying a camera view taken from (or similar to) the perspective from the cockpit. The synthetic vision system created may essentially display that camera view with other information overlaid on top by the overlay module 360. Moreover, it should be appreciated that the overlay module 360 may be configured to overlay graphical representations of various different pieces of information on top of a camera view, a map view, or various other views that can be generated on the user interface 350 (or via the vision system).

In an example embodiment, the overlay module 360 may be configured to modify image data provided to a display to overlay indicia, graphical representations, or various other enhancements over the image data. In some cases, the image data may be stored image data (e.g., of map views or captured images of places or things) that can be oriented relative to the heading of the aircraft 100 to prevent confusion for the pilot or crew. Meanwhile, additionally or alternatively, the image data may be real-time (or near real-time) image data captured by a camera forming a portion of the sensor network 330 or otherwise provided on the aircraft 100.

When the image data is a map view, a position of the aircraft 100 may be displayed on the image data by the overlay module 360 along with various other pieces of information or enhancements. For example, an intended track may be displayed along with various graphical representations of individual items of external environmental data. Each of the graphical representations may be distinct in terms of labeling, colors, intensity, icons used, or other differentiating details. Some examples of graphical representations may include weather information or data, wake vortex data, traffic data (e.g., the locations and trajectories of other aircraft or objects), animal activity (e.g., animals on or near a runway, or in flight near airports), flight path optimization data (in cooperation with the optimization module 390 as discussed below), or the like.

When the image data is a camera view, live image data may be presented on a display and the live image data may be modified by the overlay module 360 to include graphical representations as discussed above. In an example embodiment, the overlay module 360 may be configured to drive a display based on a the live image data (e.g., a real time camera view) of an area visible from the cockpit, and generate driving directions on the display. Thus, for example, as the aircraft is taxiing, signals for turning right or left (or proceeding ahead) on the taxiway may be provided in the cockpit on a display. Synthetic vision versions may also overlay the image data with images or representations of other aircraft or objects (e.g., from the external environmental data) onto the synthetic vision display generated based on the camera view. Camera or map views could also be overlaid with information indicative of restricted or authorized airspace. Warnings (audible and visual) may be provided based on proximity to restricted airspace, and when boundaries are crossed. Instructions for exiting the restricted airspace may also be automatically provided. Additionally, any of the graphical representations that can be provided on map views can also be provided on camera views as an overlay.

Wake vortex data may be generated based on information indicative of the type of aircraft generating the wake vortex and the speed, heading, altitude, etc. of the aircraft. This information may be reported by the aircraft to the information management module 150, and then communicated to other aircraft in the area (and therefore having temporal and locational relevance) to display an overlay showing the wake vortex graphically on a map or camera view. The ARM 160 may therefore be configured to model a wake vortex based on the information above, but also model movement of the wake vortex based on wind direction and strength or other environmental factors that may be included in the external environmental data.

In an example embodiment, the rules module 370 may be used to define rules for how to generate representations for certain phenomena or situations based on models and/or aviation (e.g., FAA rules). For example, the rules module 370 may include information on airspace management rules defined by the FAA so that warnings can be issued regarding restricted airspace. The rules module 370 may also include models for modeling wake vortexes and their movement. In some cases, the rules module 370 may further include information on noise restriction and models for predicting noise generation based on aircraft flying through certain airspace and environmental conditions. Various rules regarding noise generation (again, determined by the FAA) may then be enforced or at least aircraft can be notified of such rules. Accordingly, the rules module 370 may be configured to store models and/or rule sets that can be used to generate information for display as an overlay by the overlay module 360. In some cases, the rules module 370 may also allow operator input (or have predefined rules) for selection of preferred models for certain locations or situations. Thus, for example, an ability to source data from among various options or models may be provided so that weather data, location information, or other information can be obtained from the best sources at any given time or under certain circumstances.

In an example embodiment, the ARM 160 may include the voice recognition module 380, which may interface with any or all of the other modules of the ARM 160. The voice recognition module 380 may be configured to receive (e.g., via a microphone of the user interface 350) instructions from a pilot or crewmember of the aircraft 100. The voice recognition module 380 may therefore allow audible commands or inputs to be received and input into the ARM 160 so that the pilot, for example, can have hands free (relative to the ARM 160) communication with the ARM 160 to free his/her hands up for other flight related tasks.

The optimization module 390 may be configured to receive information from the external environmental data and determine optimal flight path or routing details to implement or suggest in order to optimize certain selectable parameters. For example, the optimization module 390 may be configured to determine optimal routes to minimize fuel consumption, to minimize carbon emissions, to manage contrail generation (e.g., providing instructions relative to flying above/below the tropopause and therefore in or out of the stratosphere). In some cases, the optimization module 390 may further be configured to make logistics management optimization determinations. For example, the optimization module 390 may be provided with information on fuel (including fuel cell, and electric charge capacity) capabilities at various airports or landing stations for urban air mobility environments. The ARM 160 may therefore provide instructions to the pilot or crew, via overlaid information on a display, regarding where refueling can be optimally performed and instructions on how to get there. In some cases

In some cases, the destination data 395 (stored at the ARM 160 or provided thereto by the information management module 150) may include models and/or images of airport runways and approaches, models and/or images of taxiways, models and/or images of gates or hangers, and/or the like. Thus, for example, 3D images of airports and the approached thereto can be provided by the ARM 160. However, the 3D images may be further augmented to include overlaid information of various types. Moreover, the overlaid information may include external environmental data that is supplied to the aircraft 100 in real time and while the aircraft 100 is in-flight. It should also be appreciated that the aircraft 100 may communicate (again in real time) data from the sensor network 330 back to the ground. The real time sensor network information may include camera views from the aircraft 100, and information that may also be useful for generating weather data, traffic data, animal activity data, etc. For example, if camera images from one aircraft reporting live feed to the information management module 150 shows any relevant data to another aircraft (i.e., the aircraft 100) based on locational and temporal relevance, the camera images may be used to extract external environmental data that can be communicated to the aircraft 100 and be overlaid onto display outputs to create an immersive and real time updated augmented reality (AR) environment that is facilitated by the bidirectional nature of the connectivity with all of the aircraft that communicate with the information management module 150. Moreover, this bidirectional link also creates the possibility of a live stream for sensor data off the aircraft and the creation of a real time internet of things (TOT) environment for monitoring the aircraft environment, health of various systems, maintenance situations, and/or the like.

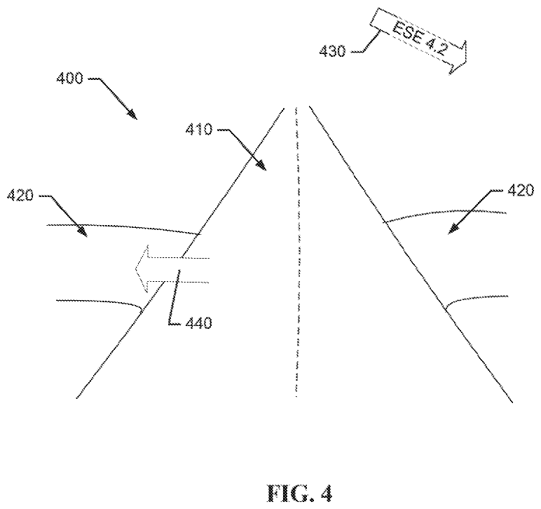

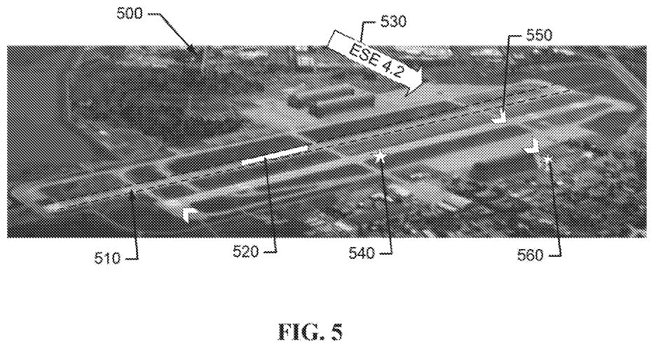

FIG. 4 illustrates an image 400 (which could either be live camera image data or synthetic image data) showing a runway 410 and taxiways 420. The overlay module 360 may add various overlays to the image 400 including, for example, weather data 430 (e.g., a wind direction and strength indicator) and driving directions 440 (e.g., a turn direction). However, it should be appreciated that any of the other items discussed above could also be added to the image 400, some examples of which are shown in FIG. 5. In this regard, FIG. 5 illustrates image data (e.g., image 500) showing an airport with multiple runways. Guidance information provided via the ARM 160 may include highlighting of a runway assignment 510 (or runway recommendation). The runway assignment 510 could further include an indication of a direction of approach 520, weather information 530 (in the form of wind strength and direction), obstacle or obstruction information 540 (e.g., an animal sighting), traffic indicators 550, and a final destination indicator 560. Each of these indicators may be differentiated by color, shape, labeling, and may move with updated external environmental data at confidence intervals, or when available due to communication from the respective services or entities (e.g., other aircraft) with the information management module 150.

Accordingly, example embodiments may enable high quality information provision into the cockpit, in real time, on the basis of connectivity. Moreover, the information provided can be used to power augmented reality vision systems that make the information easier to consume by adding it to an intuitive interface that is updated in real time.

Thus, in accordance with an example embodiment, a system for improving cockpit operations in an aircraft is provided. The system may include an airborne augmented reality module and a ground-based information management module. The augmented reality module may be disposed in the cockpit of the aircraft and may include processing circuitry configured to generate an augmented reality display in the cockpit based at least in part on selected external environmental data received. The information management module may be configured to include external environmental data received from a plurality of sources and generate the selected external environmental data for communication to the augmented reality module via a wireless communication network while the aircraft is in flight. The selected external environmental data may be selected based on aircraft location and a determination of temporal relevance and locational relevance of the selected external environmental data.

In some embodiments, the system may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the information management module may store the external environmental data in association with respective geographic areas, airports, specific locations in airspace, and specific locations on the ground for determining locational relevance, and may store the external environmental data in association with a corresponding time of collection for determining temporal relevance. In an example embodiment, the selected external environmental data may be further selected based on a confidence score. In some cases, the information management module may be configured to communicate a different set of selected external environmental data to each of a plurality of aircraft based on temporal relevance and locational relevance determinations for each respective one of the aircraft. In an example embodiment, the information management module may be configured to simultaneously communicate the different set of selected external environmental data to multiple ones of the aircraft. In some cases, the selected external environmental data may include weather data relevant to the aircraft based on a current trajectory of the aircraft, and the augmented reality module may be configured to overlay a display in the cockpit with information indicative of the weather data. In an example embodiment, the selected external environmental data may include traffic data relevant to the aircraft based on a current or future location of the aircraft, and the augmented reality module may be configured to overlay a display in the cockpit with information indicative of the traffic data. In some cases, the selected external environmental data may include wake vortex data relevant to the aircraft based on a current trajectory of the aircraft, and the augmented reality module may be configured to overlay a display in the cockpit with a visual indication of a location of a wake vortex based on the wake vortex data. In an example embodiment, the visual indication of the location of the wake vortex may be moved based on a model for approximating wake vortex movement and decay. In some cases, the selected external environmental data may include animal activity data relevant to the aircraft based on animal activity reported proximate to an airport the aircraft is departing or approaching, and the augmented reality module may be configured to overlay a display in the cockpit with visual information indicative of the animal activity data. In an example embodiment, the selected external environmental data may include airspace availability data relevant to the aircraft based on a current trajectory of the aircraft, and the augmented reality module may be configured to overlay a display in the cockpit with information indicative of available airspace in which the aircraft is authorized to fly and an indication of any restricted airspace in which the aircraft is not authorized to fly. In some cases, the selected external environmental data may include carbon or emissions management data relevant to the aircraft, and the augmented reality module may be configured to overlay a display in the cockpit with information indicative of the carbon or emissions management data. In an example embodiment, the selected external environmental data may include logistics management data relevant to the aircraft, and the augmented reality module may be configured to overlay a display in the cockpit with information indicative of the logistics management data. In some cases, the selected external environmental data may include noise management data relevant to the aircraft based on a current trajectory of the aircraft, and the augmented reality module may be configured to overlay a display in the cockpit with information indicative of the noise management data. In an example embodiment, the external environmental data may be gathered at predefined intervals, and the external environmental data gathered may replace previously stored data only when a confidence score of new data exceeds a corresponding confidence score of old data. In some cases, the augmented reality module may be operably coupled to a flight management system of the aircraft, and the augmented reality module may generate a display to indicate suggested guidance for aircraft operation based on information received from the flight management system. In an example embodiment, the augmented reality module may include a voice recognition module, and instructions for display of content via the augmented reality module may be provided by a pilot or crewmember via the voice recognition module. In some cases, the aircraft location may be either a current aircraft location or a future aircraft location. In an example embodiment, the augmented reality module may be configured to generate a display based on a real time camera view of an area visible from the cockpit, and generate an overlay on the display to indicate driving directions for the aircraft.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A system comprising:
an airborne augmented reality module disposed in a cockpit of an aircraft, the augmented reality module comprising processing circuitry configured to generate an augmented reality display in the cockpit based at least in part on selected external environmental data received; and
a ground-based information management module configured to include external environmental data received from a plurality of sources and generate the selected external environmental data for communication to the augmented reality module via a wireless communication network while the aircraft is in flight,
wherein the selected external environmental data is selected based on aircraft location and a determination of temporal relevance and locational relevance of the selected external environmental data.

2. The system of claim 1, wherein the information management module stores the external environmental data in association with respective geographic areas, airports, specific locations in airspace, and specific locations on the ground for determining locational relevance, and stores the external environmental data in association with a corresponding time of collection for determining temporal relevance.

3. The system of claim 2, wherein the selected external environmental data is further selected based on a confidence score.

4. The system of claim 1, wherein the information management module is configured to communicate a different set of selected external environmental data to each of a plurality of aircraft based on temporal relevance and locational relevance determinations for each respective one of the aircraft.

5. The system of claim 4, wherein the information management module is configured to simultaneously communicate the different set of selected external environmental data to multiple ones of the aircraft.

6. The system of claim 1, wherein the selected external environmental data includes weather data relevant to the aircraft based on a current trajectory of the aircraft, and wherein the augmented reality module is configured to overlay a display in the cockpit with information indicative of the weather data.

7. The system of claim 1, wherein the selected external environmental data includes traffic data relevant to the aircraft based on a current or future location of the aircraft, and wherein the augmented reality module is configured to overlay a display in the cockpit with information indicative of the traffic data.

8. The system of claim 1, wherein the selected external environmental data includes wake vortex data relevant to the aircraft based on a current trajectory of the aircraft, and wherein the augmented reality module is configured to overlay a display in the cockpit with a visual indication of a location of a wake vortex based on the wake vortex data.

9. The system of claim 8, wherein the visual indication of the location of the wake vortex is moved based on a model for approximating wake vortex movement and decay.

10. The system of claim 1, wherein the selected external environmental data includes animal activity data relevant to the aircraft based on animal activity reported proximate to an airport the aircraft is departing or approaching, and wherein the augmented reality module is configured to overlay a display in the cockpit with visual information indicative of the animal activity data.

11. The system of claim 1, wherein the selected external environmental data includes airspace availability data relevant to the aircraft based on a current trajectory of the aircraft, and wherein the augmented reality module is configured to overlay a display in the cockpit with information indicative of available airspace in which the aircraft is authorized to fly and an indication of any restricted airspace in which the aircraft is not authorized to fly.

12. The system of claim 1, wherein the selected external environmental data includes carbon or emissions management data relevant to the aircraft, and wherein the augmented reality module is configured to overlay a display in the cockpit with information indicative of the carbon or emissions management data.

13. The system of claim 1, wherein the selected external environmental data includes logistics management data relevant to the aircraft, and wherein the augmented reality module is configured to overlay a display in the cockpit with information indicative of the logistics management data.

14. The system of claim 1, wherein the selected external environmental data includes noise management data relevant to the aircraft based on a current trajectory of the aircraft, and wherein the augmented reality module is configured to overlay a display in the cockpit with information indicative of the noise management data.

15. The system of claim 1, wherein the external environmental data is gathered at predefined intervals, and wherein the external environmental data gathered replaces previously stored data only when a confidence score of new data exceeds a corresponding confidence score of old data.

16. The system of claim 1, wherein the augmented reality module is operably coupled to a flight management system of the aircraft, and wherein the augmented reality module generates a display to indicate suggested guidance for aircraft operation based on information received from the flight management system.

17. The system of claim 1, wherein the augmented reality module comprises a voice recognition module, and wherein instructions for display of content via the augmented reality module are provided by a pilot or crewmember via the voice recognition module.

18. The system of claim 1, wherein the aircraft location is a current aircraft location.

19. The system of claim 1, wherein the aircraft location is a future aircraft location.

20. The system of claim 1, wherein the augmented reality module is configured to generate a display based on a real time camera view of an area visible from the cockpit, and generate an overlay on the display to indicate driving directions for the aircraft.
